(19) United States
(12) Patent Application Publication
(10) Pub. No.: US 2025/0174387 A1
(43) Pub. Date: May 29, 2025

(54) INDUCTOR AND METHOD FOR MANUFACTURING THE SAME

(71) Applicant: CHILISIN ELECTRONICS CORP., TAOYUAN CITY (TW)

(72) Inventor: CHUN-CHIH LIN, TAOYUAN CITY (TW)

(21) Appl. No.: 18/595,306

(22) Filed: Mar. 4, 2024

(30) Foreign Application Priority Data
Nov. 23, 2023 (TW) 112145303

(51) Int. Cl. H01F 27/02; H01F 27/00; H01F 27/255; H01F 27/32; H01F 41/02; H01F 41/26

(52) U.S. Cl. CPC H01F 27/022; H01F 27/006; H01F 27/255; H01F 27/324; H01F 41/0246; H01F 41/26

(57) ABSTRACT

An inductor and a method for manufacturing the same are provided. The inductor includes at least two inductor structures. Each of the at least two inductor structures includes a single coil, a magnetic body, an electrode structure, and a protection structure. The single coil has a first end and a second end. The single coil is encapsulated by the magnetic body. The first end and the second end are exposed from a bottom surface of the magnetic body. The electrode structure is disposed on the bottom surface of the magnetic body. The electrode structure includes a first electrode and a second electrode that are spaced apart from each other. The first electrode is electrically connected with the first end. The second electrode is electrically connected with the second end. The first electrode and the second electrode are separated by the protection structure.

### CROSS-REFERENCE TO RELATED PATENT APPLICATION

This application claims the benefit of priority to Taiwan Patent Application No. 112145303, filed on Nov. 23, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductor and a method for manufacturing the same, and more particularly to an inductor that has high reliability and a method for manufacturing the same.

### BACKGROUND OF THE DISCLOSURE

An inductor is a common circuit element that generates an electromotive force due to the resistance to changes in passing currents. According to different configurations, the inductor can have different inductance values to meet various characteristic requirements.

However, if the configuration of the inductor needs to be redesigned each time a new inductance value is expected, considerable time or design costs will be incurred. Therefore, how to enhance the convenience of configuring the inductor through improvements in structural design has become one of the important issues to be solved in this industry.

### SUMMARY OF THE DISCLOSURE

In response to the above-referenced technical inadequacy, the present disclosure provides an inductor and a method for manufacturing the same.

In order to solve the above-mentioned problem, one of the technical aspects adopted by the present disclosure is to provide an inductor. The inductor includes at least two inductor structures. Each of the at least two inductor structures includes a single coil, a magnetic body, an electrode structure, and a protection structure. The single coil has a first end and a second end. The single coil is encapsulated by the magnetic body. The first end and the second end are exposed from a bottom surface of the magnetic body. The electrode structure is disposed on the bottom surface of the magnetic body. The electrode structure includes a first electrode and a second electrode that are spaced apart from each other. The first electrode is electrically connected with the first end. The second electrode is electrically connected with the second end. The protection structure is disposed on the bottom surface of the magnetic body, and the first electrode and the second electrode are separated by the protection structure.

In one of the possible or preferred embodiments, the first electrode and the second electrode are spaced apart by a gap larger than or equal to 0.1 mm. In one of the possible or preferred embodiments, the first end and the second end of the single coil extend toward each other without contact.

In one of the possible or preferred embodiments, the first end and the second end of the single coil extend away from each other.

In one of the possible or preferred embodiments, relative to the bottom surface, a thickness of the electrode structure is greater than a thickness of the protection structure.

In one of the possible or preferred embodiments, an outer surface of the magnetic body is jointly encapsulated by the protection structure and the electrode structure.

In one of the possible or preferred embodiments, the first electrode has a first side electrode that extends from the bottom surface toward a side surface of the magnetic body, and the second electrode has a second side electrode that extends from the bottom surface toward another side surface of the magnetic body.

In one of the possible or preferred embodiments, relative to the bottom surface, an extending height of the first side electrode is greater than or equal to 0.01 mm, and an extending height of the second side electrode is greater than or equal to 0.01 mm.

In one of the possible or preferred embodiments, relative to the bottom surface, an extending height of the first side electrode is less than or equal to a height of the magnetic body, and an extending height of the second side electrode is less than or equal to the height of the magnetic body.

In one of the possible or preferred embodiments, a material of the protection structure includes an epoxy resin, an acrylic resin, or silicone.

In one of the possible or preferred embodiments, the inductor further includes an adhesive layer disposed between two adjacent ones of the at least two inductor structures.

In one of the possible or preferred embodiments, a material of the adhesive layer is an epoxy resin, an acrylic resin, or silicone.

In one of the possible or preferred embodiments, a material of the magnetic body includes at least one of crystalline metal magnetic powder and amorphous metal magnetic powder.

In one of the possible or preferred embodiments, the crystalline metal magnetic powder is selected from the group consisting of: ferrosilicon alloy powder, ferrosilicon-chromium alloy powder, ferrosilicon-aluminum alloy powder, iron-nickel alloy powder, carbonyl iron powder, iron powder, iron-nickel-molybdenum alloy powder, and iron-cobalt-vanadium alloy powder.

In one of the possible or preferred embodiments, the amorphous metal magnetic powder is selected from the group consisting of: ferrosilicon-boron-carbon powder and ferrosilicon-chromium-boron-phosphorus-carbon powder.

In order to solve the above-mentioned problem, another one of the technical aspects adopted by the present disclosure is to provide a method for manufacturing an inductor. The method includes: preparing a single coil which has a first end and a second end; implementing a compression molding process to embed the single coil into a magnetic body, in which the first end and the second end are exposed from a bottom surface of the magnetic body; disposing a protection structure onto the bottom surface; removing a part of the protection structure so as to expose the first end and the second end from the bottom surface; implementing an electroplating process to form an electrode structure onto the bottom surface of the magnetic body so as to form an inductor structure; and fixing the two inductor structures by an adhesive layer to form an inductor. The electrode structure includes a first electrode and a second electrode that are spaced apart from each other. The first electrode is electrically connected with the first electrode, and the second electrode is electrically connected with the second electrode. The first electrode and the second electrode are separated by the protection structure.

In one of the possible or preferred embodiments, the first electrode and the second electrode are spaced apart by a gap larger than or equal to 0.1 mm.

In order to solve the above-mentioned problem, yet another one of the technical aspects adopted by the present disclosure is to provide an inductor. The inductor includes an inductor structure that includes a single coil, a magnetic body, an electrode structure, and a protection structure. The single coil has a first end and a second end. The single coil is encapsulated by the magnetic body. The first end and the second end are exposed from a bottom surface of the magnetic body. The electrode structure is disposed on the bottom surface of the magnetic body. The electrode structure includes a first electrode and a second electrode that are spaced apart from each other. The first electrode is electrically connected with the first electrode, and the second electrode is electrically connected with the second electrode. The protection structure is disposed on the bottom surface of the magnetic body. The first electrode and the second electrode are separated by the protection structure.

Therefore, in the inductor and the method for manufacturing the same provided by the present disclosure, by virtue of “the electrode structure including a first electrode and a second electrode that are spaced apart from each other” and “the first electrode and the second electrode being separated by the protection structure,” the inductor structure can have high reliability, and the inductor having various inductance values can be obtained by any arbitrary combination.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an inductor according to a first embodiment of the present disclosure;

FIG. 2 is a schematic side view of the inductor according to the first embodiment of the present disclosure;

FIG. 3 to FIG. 7 are each a schematic side view of an inductor structure during a manufacturing process according to the first embodiment of the present disclosure;

FIG. 8 is a schematic bottom view of the inductor structure of FIG. 7;

FIG. 9 is a schematic side view of the inductor structure according to one embodiment of the present disclosure;

FIG. 10 is a schematic side view of the inductor structure according to another embodiment of the present disclosure;

FIG. 11 is a schematic side view of the inductor structure according to yet another embodiment of the present disclosure;

FIG. 12 is a schematic perspective view of the inductor according to a second embodiment of the present disclosure;

FIG. 13 is a schematic perspective view of the inductor according to a third embodiment of the present disclosure; and

FIG. 14 is a schematic perspective view of the inductor according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides an inductor. The inductor includes an inductor structure. The inductor structure includes a protection structure that separates two adjacent electrodes, such that the inductor can have good reliability. In addition, the inductor structures of the present disclosure can be arbitrarily combined, thereby enabling the inductor to have various inductance values.

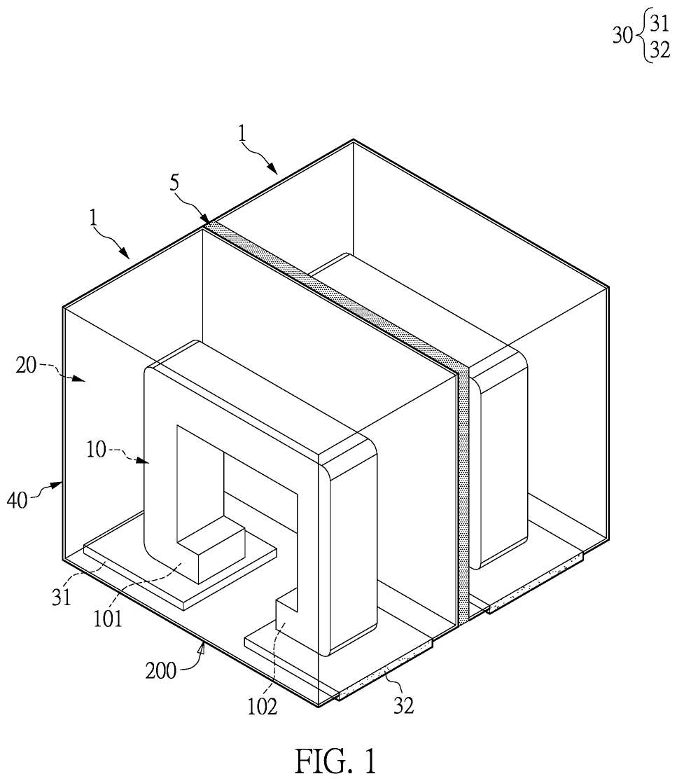

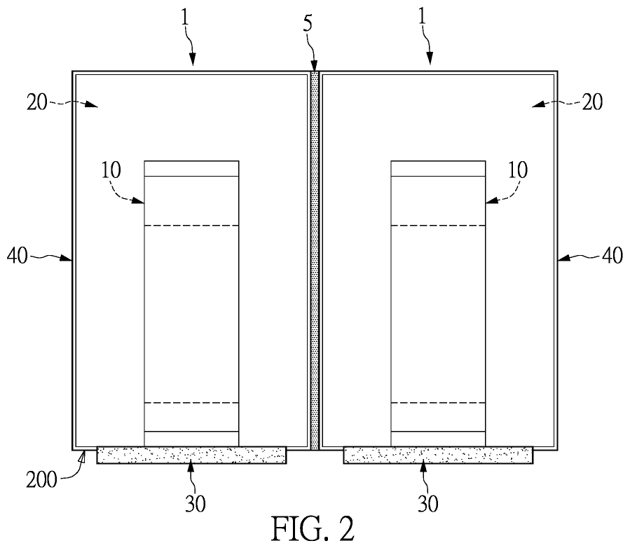

Referring to FIG. 1 and FIG. 2, the inductor of the present disclosure includes at least two inductor structures 1. These two adjacent inductor structures 1 are disposed in parallel to each other, and are fixed to each other via an adhesive layer 5. A material of the adhesive layer 5 includes an epoxy resin, an acrylic resin, or silicone. In an exemplary embodiment, the adhesive layer 5 is formed by coating, but the present disclosure is not limited thereto.

The inductor structure 1 can be regarded as a minimum structural unit. The inductance value of the inductor can be adjusted by combining the multiple inductor structures 1. Each inductor structure 1 includes a single coil 10, a magnetic body 20, an electrode structure 30, and a protection structure 40.

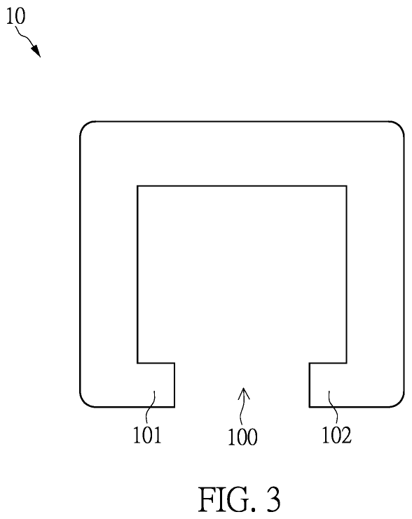

Referring to FIG. 3, the single coil 10 is an open-end coil. A first end 101 and a second end 102 of the single coil 10 are not connected with each other and do not form a closed loop. An opening 100 is formed between the first end 101 and the second end 102.

In an exemplary embodiment, two ends of the single coil 10 can be bent toward each other, and extend to form the first end 101 and the second end 102. The opening 100 is located between the first end 101 and the second end 102, as shown in FIG. 3.

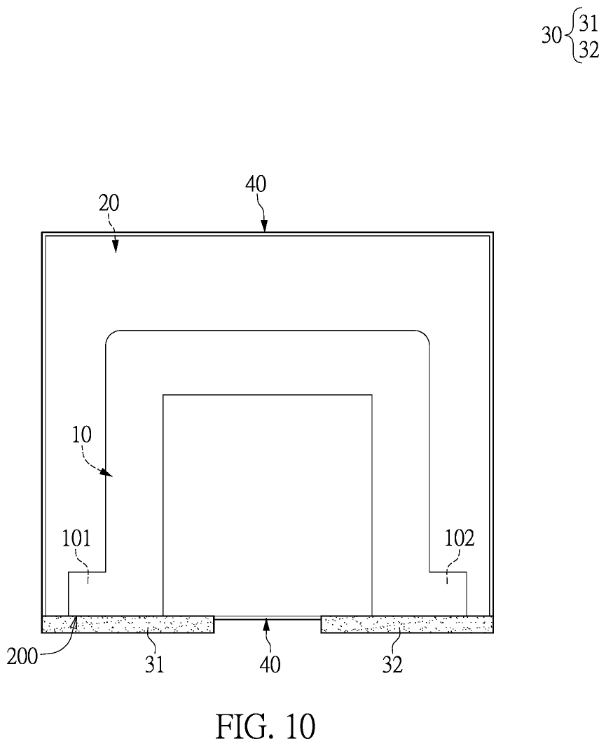

In an exemplary embodiment, the two ends of the single coil 10 can be bent away from each other, and extend to form the first end 101 and the second end 102, as shown in FIG. 10. It should be noted that the first end 101 and the second end 102 do not protrude out or are not exposed from a side surface of the magnetic body 20.

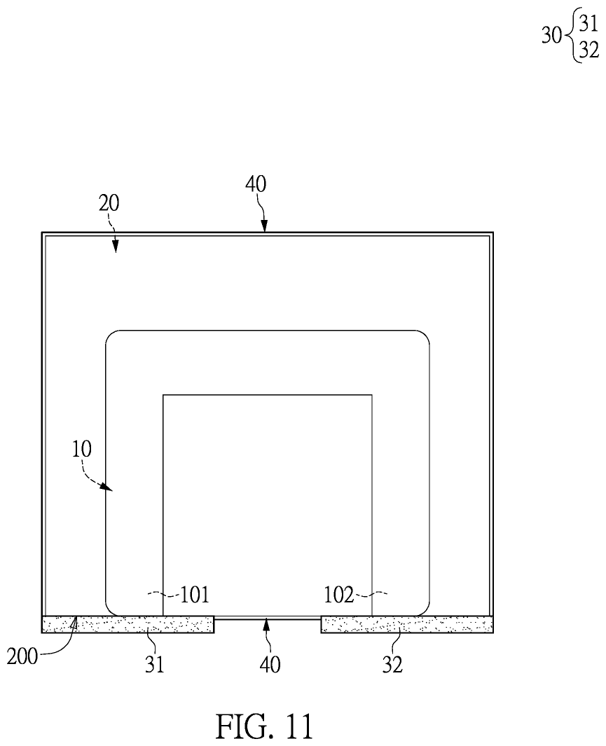

In other exemplary embodiments, the two ends of the single coil 10 can extend along the same direction without bending, as shown in FIG. 11. The size of the single coil 10 can be adjusted according to various characteristic requirements. For example, an impedance value of the inductor can be adjusted by changing a distance between the first end 101 and the second end 102.

The single coil 10 is formed from a single material, instead of a coupling coil. Specifically, an inductive coupling coefficient of the inductor can be less than 0.9. Preferably, the inductive coupling coefficient of the inductor can be less than 0.5. More preferably, the inductive coupling coefficient of the inductor can be less than 0.3, or can even be less than 0.1 or 0.08.

The appearance of the single coil 10 shown in FIG. 3 is approximately square, but is not limited thereto. The appearance of the single coil 10 may also be circular or triangular, or have other polygonal shapes. In addition, a cross section of the single coil 10 in FIG. 1 is rectangular, but is not limited thereto. The cross section of the single coil 10 may also be circular or have other shapes.

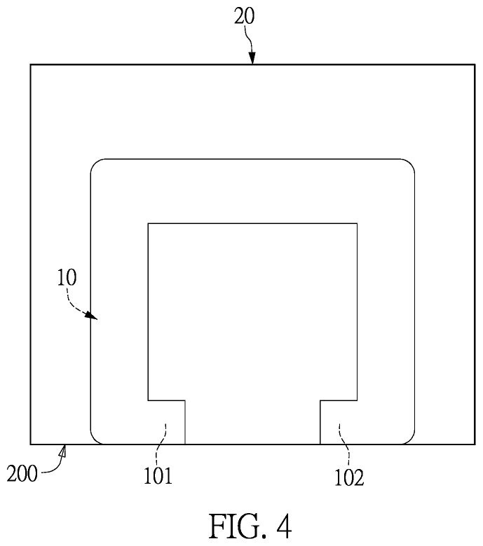

Referring to FIG. 2 and FIG. 4, the single coil 10 is encapsulated by the magnetic body 20. It should be noted that the first end 101 and the second end 102 of the single coil 10 are flush with a bottom surface 200 of the magnetic body 20. In other words, a part of the first end 101 and a part of the second end 102 are exposed from the bottom surface 200 of the magnetic body 20, as shown in FIG. 4. Accordingly, the single coil 10 can be electrically connected with an external circuit.

A material of the magnetic body 20 includes metal magnetic powder and an adhesive component. The metal magnetic powder includes at least one of crystalline metal magnetic powder and amorphous metal magnetic powder. For example, the crystalline metal magnetic powder can be ferrosilicon alloy powder, ferrosilicon-chromium alloy powder, ferrosilicon-aluminum alloy powder, iron-nickel alloy powder, carbonyl iron powder, iron powder, iron-nickel-molybdenum alloy powder, iron-cobalt-vanadium alloy powder, or a combination thereof. The amorphous metal magnetic powder can be ferrosilicon-boron-carbon powder, ferrosilicon-chromium-boron-phosphorus-carbon powder, or a combination thereof. The adhesive component can be an epoxy resin, an acrylic resin, or silicone.

Since the material of the magnetic body 20 is a mixture containing the metal magnetic powder and the adhesive component, the magnetic body 20 can be formed by a compression molding process. However, the present disclosure is not limited thereto.

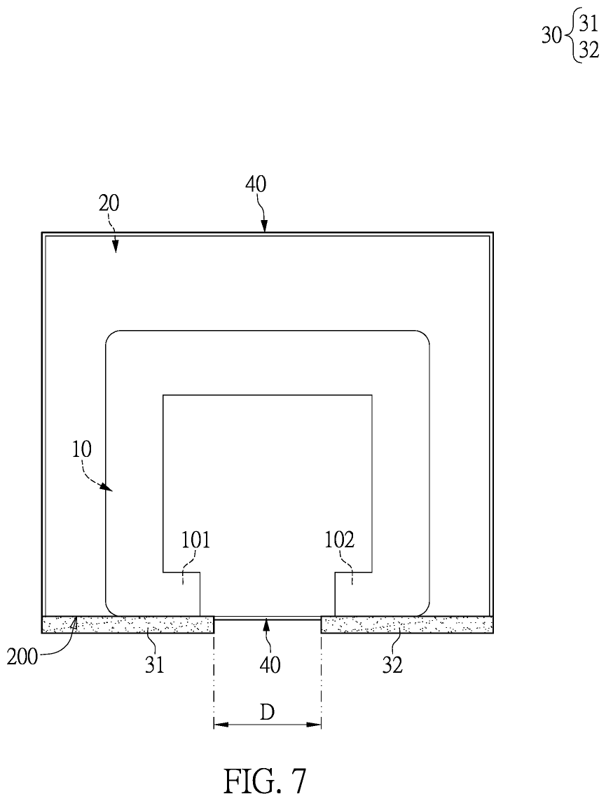

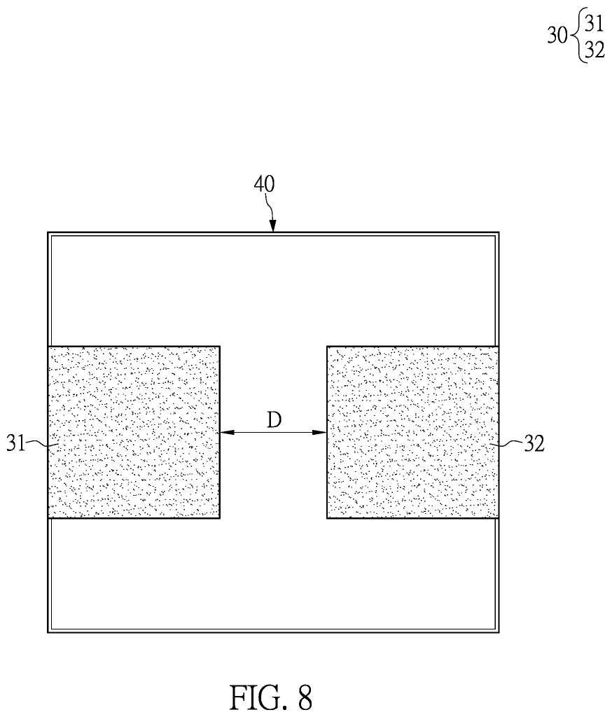

Referring to FIG. 1, FIG. 2, FIG. 7, and FIG. 8, the electrode structure 30 is disposed on the bottom surface 20 of the magnetic body 20. The electrode structure 30 includes a first electrode 31 and a second electrode 32 which are spaced apart from each other. The first electrode 31 contacts and is electrically connected with the first end 101. The second electrode 32 contacts and is electrically connected with the second end 102. Accordingly, the single coil 10 can be electrically connected with the external circuit via the electrode structure 30.

Referring to FIG. 7, relative to the bottom surface 200, a thickness of the electrode structure 30 can be higher than a thickness of the protection structure 40. Therefore, during a soldering process, a solder can be easily disposed and fixed onto the electrode structure 30.

Referring to FIG. 8, in order to prevent a short circuit, the first electrode 31 and the second electrode 32 are spaced apart by a gap D. Specifically, the gap D is larger than or equal to 0.1 mm.

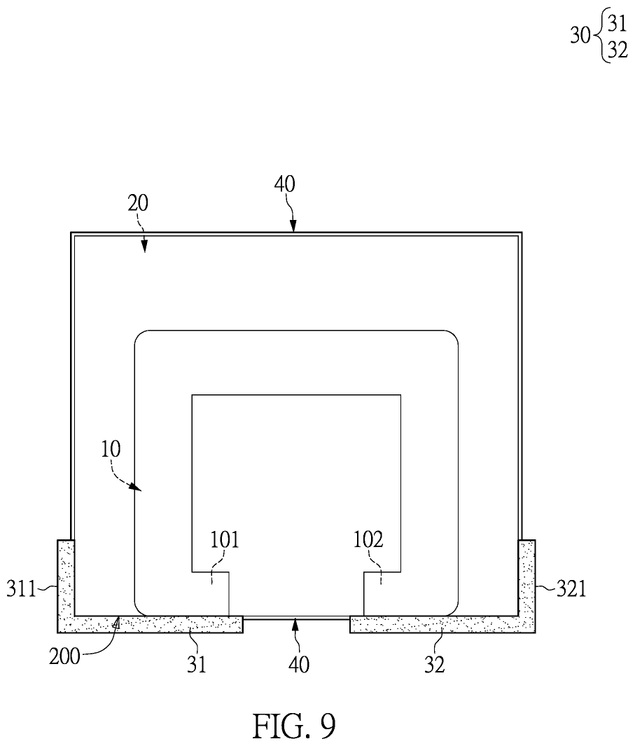

Referring to FIG. 9, in addition to being disposed on the bottom surface 200, the electrode structure 30 can also be disposed on the side surface of the magnetic body 20 in an extended manner, such that an L-shaped electrode structure is formed. Accordingly, the electrode structure 30 has a larger contact area with the solder, thereby enhancing a bonding force.

Specifically, the first electrode 31 can have a first side electrode 311 extending from the bottom surface 200 toward one side surface of the magnetic body 20. Relative to the bottom surface 200, an extending height of the first side electrode 311 is higher than or equal to 0.01 mm. Similarly, the second electrode 32 can have a second side electrode 321 extending from the bottom surface 200 toward another side surface of the magnetic body 20. Relative to the bottom surface 200, an extending height of the second side electrode 321 is higher than or equal to 0.01 mm.

By virtue of the first side electrode 311 and the second side electrode 321, the bonding force of the inductor disposed on a printed circuit board (PCB) can be enhanced. In the present disclosure, relative to the bottom surface 200, the extending heights of the first side electrode 311 and the second side electrode 321 are each lower than or equal to a height of the magnetic body 20. For example, the extending heights of the first side electrode 311 and the second side electrode 321 are each 0.2 times, 0.4 times, 0.6 times, 0.8 times, or 1 time the height of the magnetic body 20, but the present disclosure is not limited thereto.

In an exemplary embodiment, a material of the electrode structure 30 can be at least one of copper, nickel, and tin. For example, the material of the electrode structure 30 can be a copper-nickel alloy, a tin-copper alloy, or a copper-nickel-tin alloy. Alternatively, the electrode structure 30 can include a copper layer, a nickel layer, and a tin layer that are sequentially arranged, and the copper layer is in contact with the first end 101 or the second end 102.

Referring to FIG. 7 and FIG. 8, the protection structure 40 is disposed on the bottom surface 200 of the magnetic body 20. Moreover, the protection structure 40 is disposed between the first electrode 31 and the second electrode 32. In order words, the protection structure 40 is disposed on the gap D.

The protection structure 40 can act as a wall between the first electrode 31 and the second electrode 32. Since metal cannot be deposited onto the protection structure 40 during an electroplating process, the protection structure 40 can prevent the first electrode 31 and the second electrode 32 from connecting with each other.

In the embodiment shown in FIG. 8, the protection structure 40 is formed to have an H-shape on the bottom surface 200, such that the first electrode 31 and the second electrode 32 can be separated from each other. However, the shape of the protection structure 40 is not limited thereto.

Referring to FIG. 7, in addition to the bottom surface 200, the protection structure 40 can also be disposed on other surfaces of the magnetic body 20. Accordingly, the magnetic body 20 can be jointly encapsulated by the protection structure 40 and the electrode structure 30, so as to prevent the magnetic body 20 or the single coil 10 from being in contact with an external environment.

A material of the protection structure 40 can include an epoxy resin, an acrylic resin, or silicone. In an exemplary embodiment, the protection structure 40 can be formed by coating, but the present disclosure is not limited thereto.

### First Embodiment

Referring to FIG. 1 to FIG. 8, the inductor in the first embodiment of the present disclosure can be manufactured by the following steps.

In step S1, the single coil 10 having two open ends (as shown in FIG. 3) is prepared. The single coil 10 is disposed into a mold with the opening 100 between the two open ends facing downward, such that the first end 101 and the second end 102 are in contact with a bottom portion of the mold.

In step S2, a material for forming the magnetic body 20 is prepared, and is then filled into the mold to cover the single coil 10. Subsequently, the material is subjected to a compression molding process and then solidified to form the magnetic body 20. The single coil 10 is encapsulated by the magnetic body 20 (as shown in FIG. 4).

Since the first end 101 and the second end 102 are in contact with the bottom portion of the mold, the first end 101 and the second end 102 are exposed from the bottom surface 200 of the magnetic body 20 after the compression molding process.

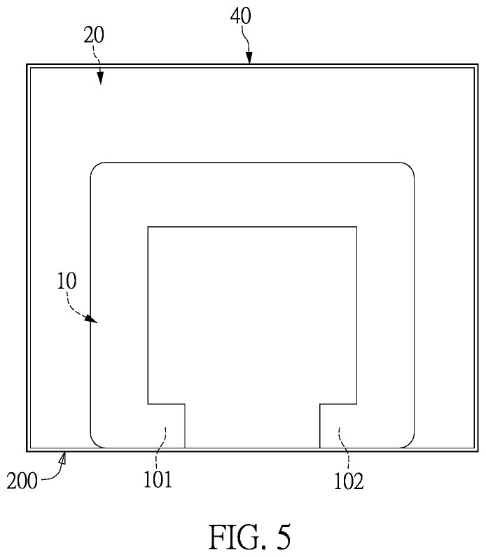

In step S3, the protection structure 40 is formed onto the outer surface (including the bottom surface 200) of the magnetic body 20 by coating, as shown in FIG. 5. In other embodiments, the protection structure 40 can also be formed only onto the bottom surface 200 of the magnetic body 20.

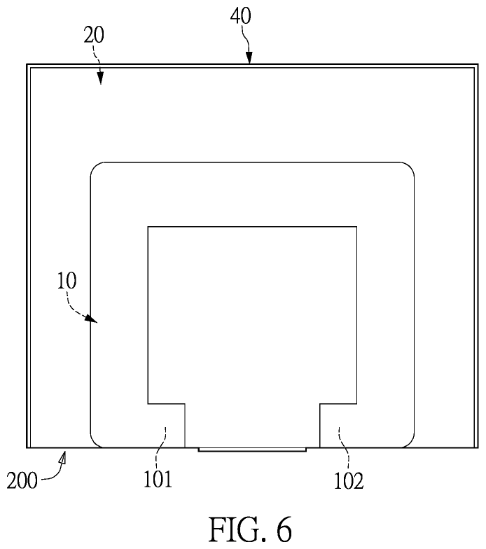

In step S4, a part of the protection structure 40 can be removed by laser or grinding, so as to expose the first end 101 and the second end 102 from the bottom surface 200 of the magnetic body 20 (as shown in FIG. 6). It should be noted that the protection structure 40 between the first end 101 and the second end 102 needs to be retained, so as to separate the first end 101 and the second end 102.

In step S5, the electrode structure 30 is formed onto the bottom surface 200 of the magnetic body 20 by the electroplating process, so as to obtain the inductor structure 1. The protection structure 40 is not conductive. Hence, the electrode structure 30 is not formed onto the protection structure 40, but is only formed onto the magnetic body 20 and the first end 101 and the second end 102 that are exposed from the bottom surface 200.

According to different formation positions, the electrode structure 30 can be classified into the first electrode 31 that contacts the first end 101 and the second electrode 32 that contacts the second end 102. In addition, the first electrode 31 and the second electrode 32 are not in contact with each other and are separated by the gap D, as shown in FIG. 7 and FIG. 8.

In step S6, the at least two inductor structures 1 are fixed by the adhesive layer 5 to manufacture the inductor, as shown in FIG. 2. Specifically, the at least two inductor structures 1 are arranged in parallel to each other.

In the present disclosure, the inductor structures 1 being arranged in parallel to each other indicates that the single coils 10 of the inductor structures 1 are disposed in parallel to each other. When the current passing through the single coils 10 changes, the single coils 10 can generate an electromotive force in the same direction. Accordingly, the properties of the inductor can be adjusted by combining multiple ones of the inductor structures 1.

It should be noted that the material of the adhesive layer 5 is similar to the material of the protection structure 40 for enhancement of their compatibility. Therefore, when two adjacent ones of the inductor structures 1 are connected by the adhesive layer 5, a good bonding force can be achieved.

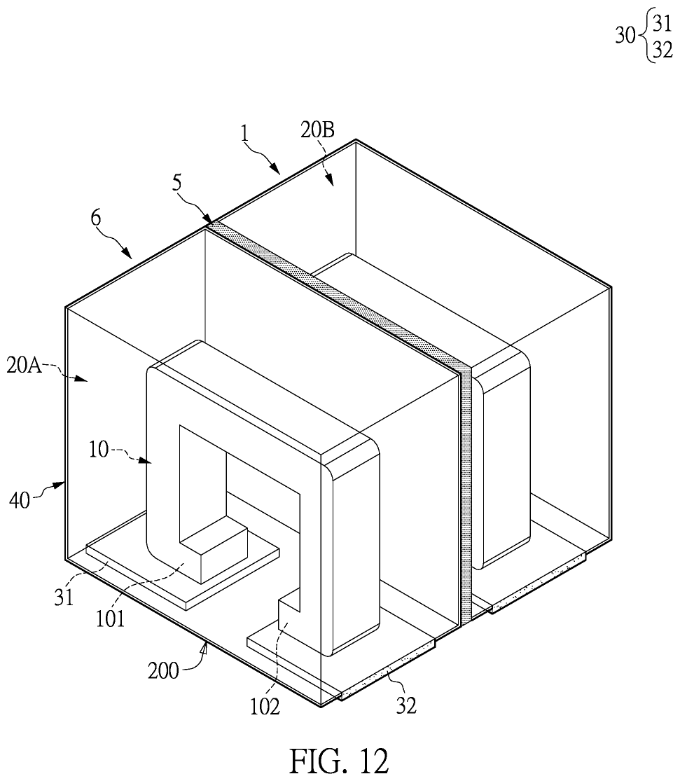

The inductor of the present disclosure can be formed from a plurality of inductor structures that are the same or different from each other. In the first embodiment, the inductor is formed from the same inductor structures (as shown in FIG. 1). In the second to fourth embodiments, the inductors are formed from different inductor structures (as shown in FIG. 12 to FIG. 14).

Referring to FIG. 12, in the second embodiment, an inductor structure 6 has a structure similar to that of the inductor structure 1. The difference is that a magnetic body 20A of the inductor structure 6 is different from the magnetic body 20 of the inductor structure 1.

For example, the magnetic body 20A of the inductor structure 6 is formed from carbonyl iron powder and an epoxy resin adhesive, and a magnetic body 20B of the inductor structure 1 is formed from iron-nickel alloy powder and an epoxy resin adhesive.

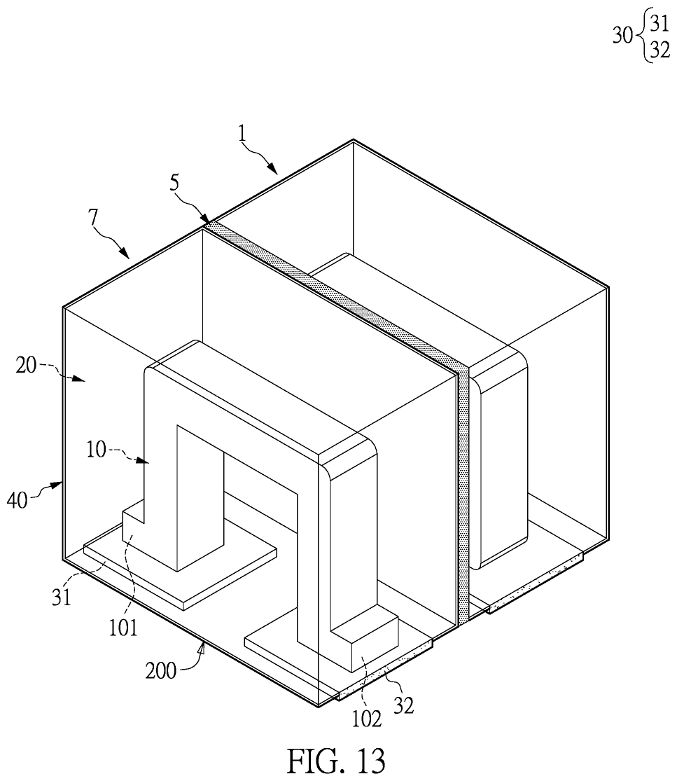

Referring to FIG. 13, in the third embodiment, an inductor structure 7 has a structure similar to that of the inductor structure 1. The difference is that the two ends of the single coil 10 of the inductor structure 1 extend toward each other to form the first end 101 and the second end 102, and the two ends of the single coil 10 of the inductor structure 7 extend away from each other to form the first end 101 and the second end 102.

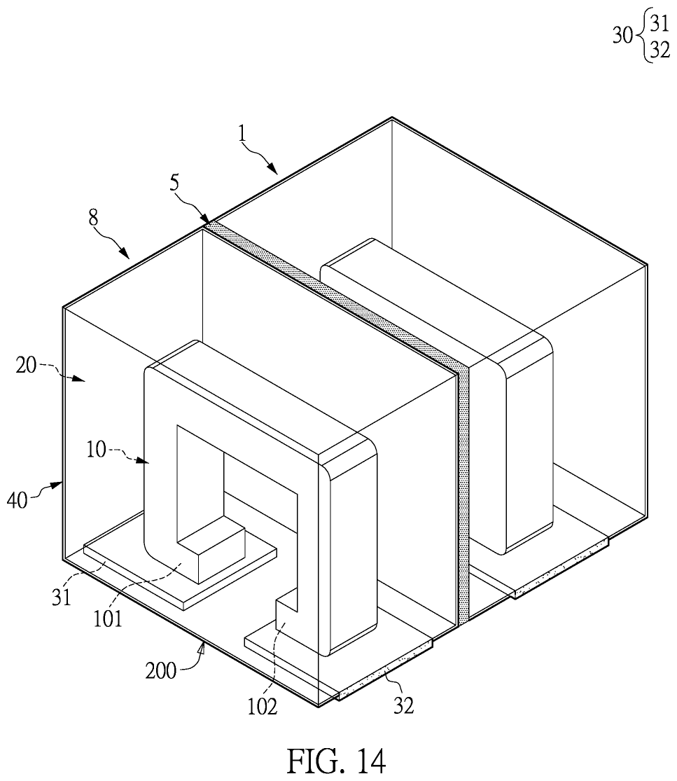

Referring to FIG. 14, in the fourth embodiment, an inductor structure 8 has a structure similar to that of the inductor structure 1. The difference is that the single coil 10 of the inductor structure 1 is thicker than the single coil 10 of the inductor structure 8 along an induced magnetic field direction.

### Beneficial Effects of the Embodiments

In conclusion, in the inductor and the method for manufacturing an inductor provided by the present disclosure, by virtue of “the electrode structure including a first electrode and a second electrode that are spaced apart from each other” and “the first electrode and the second electrode being separated by the protection structure,” the inductor structure can have high reliability, and the inductor can have various inductance values by any arbitrary combination.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductor, comprising at least two inductor structures, wherein each of the at least two inductor structures includes:
a single coil having a first end and a second end;
a magnetic body encapsulating the single coil, wherein the first end and the second end are exposed from a bottom surface of the magnetic body;
an electrode structure disposed on the bottom surface of the magnetic body, wherein the electrode structure includes a first electrode and a second electrode that are spaced apart from each other, the first electrode is electrically connected with the first end, and the second electrode is electrically connected with the second end; and
a protection structure disposed on the bottom surface of the magnetic body, wherein the first electrode and the second electrode are separated by the protection structure.

2. The inductor according to claim 1, wherein the first electrode and the second electrode are spaced apart by a gap larger than or equal to 0.1 mm.

3. The inductor according to claim 1, wherein the first end and the second end of the single coil extend toward each other without contact.

4. The inductor according to claim 1, wherein the first end and the second end of the single coil extend away from each other.

5. The inductor according to claim 1, wherein, relative to the bottom surface, a thickness of the electrode structure is greater than a thickness of the protection structure.

6. The inductor according to claim 1, wherein an outer surface of the magnetic body is jointly encapsulated by the protection structure and the electrode structure.

7. The inductor according to claim 1, wherein the first electrode has a first side electrode that extends from the bottom surface toward a side surface of the magnetic body, and the second electrode has a second side electrode that extends from the bottom surface toward another side surface of the magnetic body.

8. The inductor according to claim 7, wherein, relative to the bottom surface, an extending height of the first side electrode is greater than or equal to 0.01 mm, and an extending height of the second side electrode is greater than or equal to 0.01 mm.

9. The inductor according to claim 7, wherein, relative to the bottom surface, an extending height of the first side electrode is less than or equal to a height of the magnetic body, and an extending height of the second side electrode is less than or equal to the height of the magnetic body.

10. The inductor according to claim 1, wherein a material of the protection structure includes an epoxy resin, an acrylic resin, or silicone.

11. The inductor according to claim 1, further comprising an adhesive layer disposed between two adjacent ones of the at least two inductor structures.

12. The inductor according to claim 11, wherein a material of the adhesive layer is an epoxy resin, an acrylic resin, or silicone.

13. The inductor according to claim 1, wherein a material of the magnetic body includes at least one of crystalline metal magnetic powder and amorphous metal magnetic powder.

14. The inductor according to claim 13, wherein the crystalline metal magnetic powder is selected from the group consisting of: ferrosilicon alloy powder, ferrosilicon-chromium alloy powder, ferrosilicon-aluminum alloy powder, iron-nickel alloy powder, carbonyl iron powder, iron powder, iron-nickel-molybdenum alloy powder, and iron-cobalt-vanadium alloy powder.

15. The inductor according to claim 13, wherein the amorphous metal magnetic powder is selected from the group consisting of: ferrosilicon-boron-carbon powder and ferrosilicon-chromium-boron-phosphorus-carbon powder.

16. A method for manufacturing an inductor, comprising:
preparing a single coil that has a first end and a second end;
implementing a compression molding process to embed the single coil into a magnetic body, wherein the first end and the second end are exposed from a bottom surface of the magnetic body;
disposing a protection structure onto the bottom surface;
removing a part of the protection structure to expose the first end and the second end from the bottom surface;
implementing an electroplating process to form an electrode structure onto the bottom surface of the magnetic body, so as to form an inductor structure; wherein the electrode structure includes a first electrode and a second electrode that are spaced apart from each other, the first electrode is electrically connected with the first end, the second electrode is electrically connected with the second end, and the first electrode and the second electrode are separated by the protection structure; and
fixing the two inductor structures by an adhesive layer, so as to manufacture the inductor.

17. The inductor according to claim 16, wherein the first electrode and the second electrode are spaced apart by a gap larger than or equal to 0.1 mm.

18. An inductor, comprising an inductor structure, wherein the inductor structure includes:
a single coil having a first end and a second end;
a magnetic body encapsulating the single coil, wherein the first end and the second end are exposed from a bottom surface of the magnetic body;
an electrode structure disposed on the bottom surface of the magnetic body, wherein the electrode structure includes a first electrode and a second electrode that are spaced apart from each other, the first electrode is electrically connected with the first end, and the second electrode is electrically connected with the second end; and
a protection structure disposed on the bottom surface of the magnetic body, wherein the first electrode and the second electrode are separated by the protection structure.
